(19) United States
(12) Patent Application Publication
(10) Pub. No.: US 2024/0174114 A1
(43) Pub. Date: May 30, 2024

(54) DEVICE FOR ACQUIRING, SYSTEM, AND METHOD OF ACQUIRING, AND RECORDING MEDIUM

(71) Applicant: Mikiro KURODA, Kanagawa (JP)

(72) Inventor: Mikiro KURODA, Kanagawa (JP)

(21) Appl. No.: 18/522,305

(22) Filed: Nov. 29, 2023

(30) Foreign Application Priority Data
Nov. 30, 2022 (JP) 2022-191975
Sep. 20, 2023 (JP) 2023-153879

(51) Int. Cl. B60L 53/66; B60L 53/65

(52) U.S. Cl. CPC B60L 53/665; B60L 53/65; H04L 9/50

(57) ABSTRACT

A device for acquiring an asset, includes: a memory that stores acquirer identification information for identifying an acquirer of the asset; and circuitry configured to receive provider identification information for identifying a provider of the asset, measure an amount of the asset acquired, and transmit the acquirer identification information stored in the memory, the provider identification information that is received, and the amount of the asset acquired, each to be received at a blockchain network.

### CROSS-REFERENCE TO RELATED APPLICATIONS

This patent application is based on and claims priority pursuant to 35 U.S.C. § 119(a) to Japanese Patent Application Nos. 2022-191975, filed on Nov. 30, 2022, and 2023-153879, filed on Sep. 20, 2023, in the Japan Patent Office, the entire disclosure of each is hereby incorporated by reference herein.

### BACKGROUND

### Technical Field

The present disclosure relates to a device for acquiring, a system, a method of acquiring, and a recording medium.

### Related Art

As the global decarbonization movement gains momentum, it is desired to demonstrate that electric power used by companies is sourced from renewable energy to enhance their corporate image. In view of this, it has been proposed to use a blockchain network, as a common data infrastructure, to manage whether or not supplied electric power has been produced from renewable energy.

Further, in order for companies or individuals to receive subsidies from national or local public organizations, it is necessary to prove that not only companies but also individuals are using electric power derived from renewable energy.

As a device that records data of an amount of power generation and an amount of power consumption, devices including a power conditioning system (PCS) at a power generation facility, a watt-hour meter (smart meter) at a consumer's facility, and an energy management system (EMS) connected to the watt-hour meter, are already available. These devices are typically provided at facilities designated as targets for data measurement, and such targets do not change frequently. In other words, it would be easy to uniquely associate electric power derived from renewable energy and a target for electric power supply, which is the data measurement target. This means that it would be easy to prove that a certain company or an individual has purchased or used electric power derived from renewable energy by using the blockchain network.

Similarly, data regarding electric power charged to an electric vehicle can be recorded on the blockchain network. In such case, it is assumed that data on a charging amount is recorded at a charging facility (a charging station or a household charging outlet) where the electric vehicle is charged. However, there are an unspecified number of electric vehicles to be charged, and it would be difficult to uniquely identify each electric vehicle. When recording data at the charging facility, there would be no means to identify a particular electric vehicle, which has been charged with electric power, even using the blockchain network.

### SUMMARY

Example embodiments include a device for acquiring an asset, includes: a memory that stores acquirer identification information for identifying an acquirer of the asset; and circuitry to receive provider identification information for identifying a provider of the asset, measure an amount of the asset acquired, and transmit the acquirer identification information stored in the memory, the provider identification information that is received, and the amount of the asset acquired, each to be received at a blockchain network.

Example embodiments include a system including a device for acquiring an asset, which includes: a memory that stores acquirer identification information for identifying an acquirer of the asset; and circuitry configured to receive provider identification information for identifying a provider of the asset, measure an amount of the asset acquired, and transmit the acquirer identification information stored in the memory, the provider identification information that is received, and the amount of the asset acquired, each to be received at a blockchain network; and a device for providing the asset.

Example embodiments include a method of acquiring an asset, including: storing, in a memory, acquirer identification information for identifying an acquirer of the asset; receiving provider identification information for identifying a provider of the asset; measuring an amount of the asset acquired; and transmitting the acquirer identification information stored in the memory, the provider identification information that is received, and the amount of the asset acquired, each to be received at a blockchain network.

Example embodiments include a non-transitory recording medium which, when executed by one or more processors, causes the one or more processors to perform a method of acquiring an asset, including: storing, in a memory, acquirer identification information for identifying an acquirer of the asset; receiving provider identification information for identifying a provider of the asset; measuring an amount of the asset acquired; and transmitting the acquirer identification information stored in the memory, the provider identification information that is received, and the amount of the asset acquired, each to be received at a blockchain network.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of a charging system according to an embodiment;

FIG. 2 is a diagram illustrating a hardware configuration of each of a charging device, a charging connector, an intermediary server, a retailer terminal, and a node, with electrical connections, according to the embodiment;

FIG. 3 is a diagram illustrating a functional configuration of the charging connector, the retailer terminal, and the node, of the charging system of FIG. 1, according to the embodiment;

FIG. 4 is a conceptual diagram illustrating an example acquirer identification information management table;

FIG. 5 is a conceptual diagram illustrating an example charging data management table;

FIG. 6 is a sequence diagram illustrating processing of charging a battery of an electric vehicle with electric power supplied from the charging connector of the charging system of FIG. 1, according to an embodiment;

FIG. 7 is a sequence diagram illustrating processing of registering a purchase of electric power produced from renewable energy, performed by the charging connector of the charging system of FIG. 1, according to an embodiment; and

FIG. 8 is a conceptual diagram illustrating asset information, according to an embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments are described in detail below, with reference to the drawings.

### Overview of System Configuration

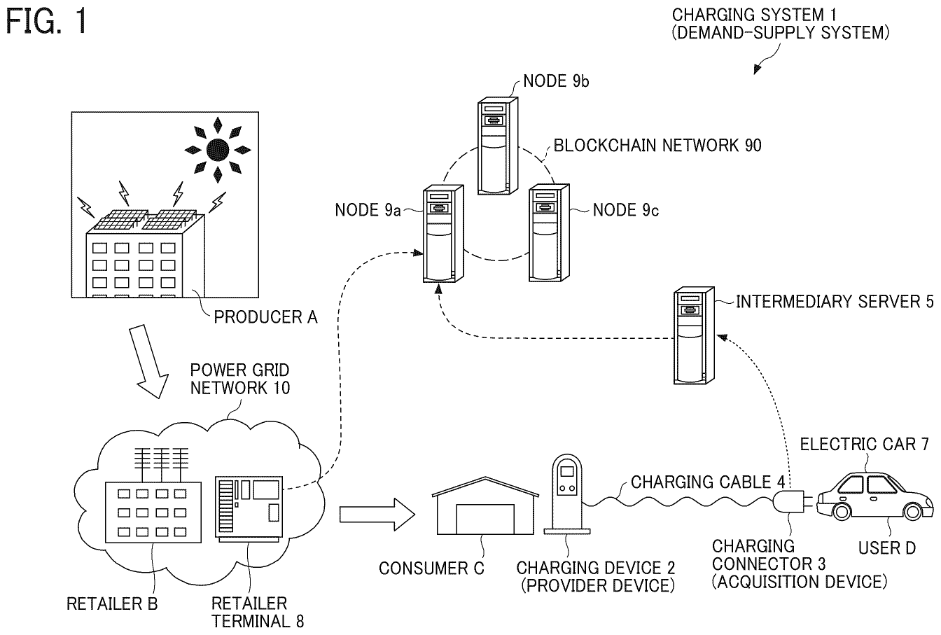

First, overview of a configuration of a charging system 1 is described according to an embodiment. FIG. 1 is a schematic view of the charging system 1 according to the embodiment. In this disclosure, an example case in which electricity is used as an example of an asset is described. The ownership of the asset and the production method of the asset are managed using asset information described later.

### Explanation on Each Entity

As illustrated in FIG. 1, the charging system 1 includes a producer A of electricity, a retailer B of electricity, a consumer C of electricity, and a user D of electricity.

The producer A is an entity, an individual or an organization, which produces electricity from renewable energy resource (referred to as “green power” in Japan). Such electricity produced from renewable energy resource is referred to as renewable energy-based electricity. Further, in this disclosure, electricity and electric power may be used interchangeably. The producer A may be a union that purchases electric power from each producer and resells the electric power. Example types of method for producing renewable energy-based electricity include a production method using solar light or solar heat, a production method using wind power, a production method using biomass, a production method using geothermal power, a production method using hydroelectric resources, a production method using heat in the atmosphere, and a production method using nuclear power.

The retailer B is, for example, an electric power company that purchases electric power from the producer A or sells electric power produced by the retailer B. In some examples, electric power to be sold by the retailer B may include not only electric power produced from renewable energy, but also electric power produced from fossil fuel. Example types of method for producing electric power produced from fossil fuel include a production method using fossil fuel, petroleum, coal, or liquefied natural gas. The retailer B has a retailer terminal 8 used for accessing the blockchain network 90.

The consumer C is a trader who sells the electric power purchased from the retailer B to another consumer (user D), who is an end-user. For example, the consumer C is an owner, manager, or operator of a charging station. At the charging station, a charging device 2 is installed.

The user D is an entity, such as an individual or an organization such as a company, who uses electric power by charging an electric vehicle 7 of the individual (or the organization such as the company) at the charging station or any other facility. In the present embodiment, the electric vehicle 7 is equipped with a dedicated charging connector 3. To charge the electric vehicle 7, the user D inserts a charging cable 4 attached to the charging connector 3 into a port of the charging device 2, such that the electric vehicle 7 is charged with electric power via the charging connector 3. Alternatively, when a charging connector (or a charging cable) attached to the charging device 2 is used, the charging cable 4 (or the charging connector 3) may be connected to the charging connector (or the charging cable) of the charging device 2, such that electric power is supplied to the electric vehicle 7 via the charging connector 3.

The charging connector 3 is able to access the blockchain network 90 via an intermediary server 5. Such access may be made via wired communication or wireless communication. In the case of wireless communication, for example, 4G, 5G, 66G, or LPWA (Low Power Wide Area-network) may be used. Depending on the specification of the charging connector 3, the charging connector 3 may not communicate via the intermediary server 5.

In this embodiment, the producer A may also be provided with a communication terminal capable of accessing the blockchain network 90.

### Power Grid Network

The electricity produced by the producer A is supplied to the consumer C via a power grid network 10, which includes the retailer B. The power grid network 10 includes substations, transmission lines, and distribution lines, etc.

### Data Communication Network

The nodes 9a, 9b, and 9c form a blockchain network 90. The blockchain network 90 is formed on a communication network such as the Internet. The communication network includes the Internet, a mobile communication network, a local area network (LAN), etc. Although there are actually a large number of nodes exist, only three nodes 9a. 9b, and 9c are illustrated in the figure for simplicity. The nodes 9a, 9b, and 9c are managed by companies different from each other. Such different companies may include the retailer B. In this disclosure, the nodes 9a, 9b, and 9c may be collectively referred to as the node 9.

### Hardware Configuration

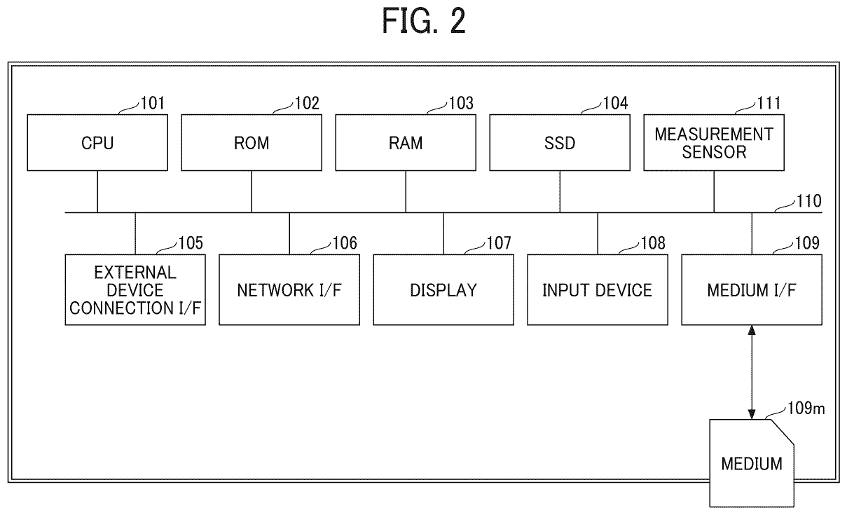

Referring now to FIG. 2, a hardware configuration of each of the charging device 2, the charging connector 3, the intermediary server 5, the retailer terminal 8, and the node 9, with electrical connections, is described according to the embodiment. FIG. 2 is a diagram illustrating a hardware configuration of each of the charging device 2, the charging connector 3, the intermediary server 5, the retailer terminal 8, and the node 9, with electrical connections.

As illustrated in FIG. 2, at least a control section of the charging connector 3 is implemented by a computer, which includes a central processing unit (CPU) 101, a read only memory (ROM) 102, a random access memory (RAM) 103, a solid state drive (SSD) 104, an external device connection interface (I/F) 105, a network I/F 106, a display 107, an input device 108, a medium I/F 109, and a bus line 110.

The CPU 101, which is a processor, controls entire operation of the charging connector 3. The ROM 102 stores a program for booting the CPU 101 such as an initial program loader (IPL). The RAM 103 is used as a work area for the CPU 101.

The SSD 104 reads or writes various types of data from or to any desired memory under control of the CPU 101. A hard disk drive (HDD) may be used instead of the SSD 104.

The external device connection I/F 105 is an interface circuit that connects the computer to various external devices. Examples of the external device include a communication device (communication circuit), a display, a speaker, a keyboard, a mouse, a universal serial bus (USB) memory, and a printer.

The network I/F 106 is an interface circuit that communicates data via a communication network such as the Internet. The communication may be wireless or wired.

The display 107 is an example of display means that displays various images, such as a liquid crystal display (LCD) and an organic electroluminescence (EL) display.

The input device 108 is an example of input means that allows a user to select or execute various instructions, select a target for processing, or move a cursor. Examples of the input device 108 include a pointing device and a touch panel.

The medium I/F 109 controls reading and writing (storing) of data from and to a recording medium 109m such as a flash memory. Examples of the recording medium 109m include a DVD (Digital Versatile Disk) and a BLU-RAY DISC.

The bus line 110 is, for example, an address bus or a data bus, which electrically connects the elements, such as the CPU 101, illustrated in FIG. 2, with each other.

Since the charging device 2, the intermediary server 5, the retailer terminal 8, and the node 9 have substantially the same configuration as that of the computer illustrated in FIG. 2 that implements the charging connector 3, description thereof will be omitted. In addition to the elements illustrated in FIG. 2, the charging device 2, the charging connector 3, and the retailer terminal 8 each includes a measurement sensor 111 that measures an amount of electric power that is supplied or consumed.

### Functional Configuration

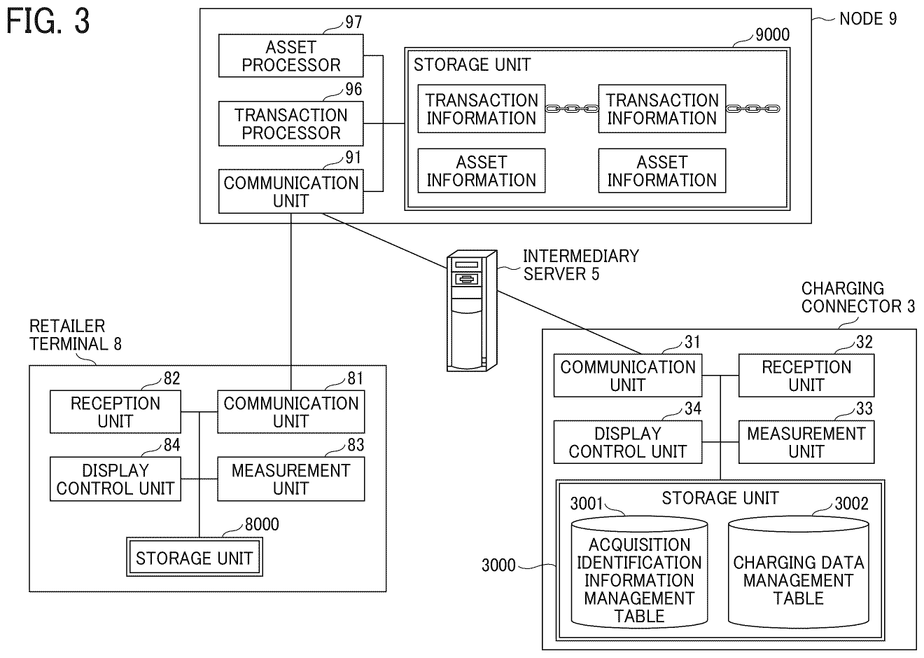

Referring now to FIGS. 3 to 5, a functional configuration of each terminal or device of the charging system 1 (charging connector 3, retailer terminal 8, node 9) is described according to the embodiment. FIG. 3 is a diagram illustrating a functional configuration of the charging connector 3, the retailer terminal 8, and the node 9, according to the embodiment.

### Functional Configuration of Charging Connector

As illustrated in FIG. 3, the charging connector 3 includes a communication unit 31, a reception unit 32, a measurement unit 33, and a display control unit 34. These units are functions implemented by or caused to function by operating any of the hardware elements illustrated in FIG. 2 in cooperation with the instructions of the CPU 101 according to the control program expanded from the SSD 104 to the RAM 103.

The charging connector 3 further includes a storage unit 3000, which is implemented by the ROM 102, the RAM 103, and the SSD 104 illustrated in FIG. 2,
acquirer identification information Management Table

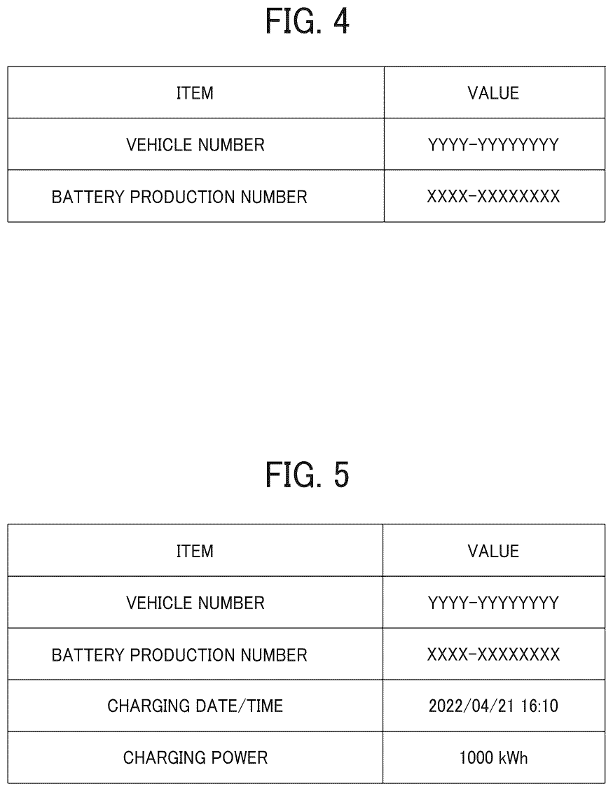

FIG. 4 is a conceptual diagram illustrating an example of an acquirer identification information management table. The storage unit 3000 stores an acquirer identification information management table 3001. The acquirer identification information management table 3001 stores acquirer identification information used for identifying an object or an entity that acquires electric power, which may be referred to as an acquirer. The table of FIG. 4 illustrates a set of a vehicle number and a battery production number as an example of the acquirer identification information for identifying an object that acquires electric power (in this example, the electric vehicle 7). In this case, even if the electric vehicle has the same vehicle number, the acquirer identification information changes when a battery is replaced. The acquirer identification information may be one of a vehicle number and a battery production number, in alternative to a set of the vehicle number and the battery production number Other examples of the acquirer identification information include a number for uniquely identifying an individual, which may be designated by a local public institution, such as a my number in Japan, and an email address or a telephone number of the individual or the company. In such case, the acquirer identification information identifies an entity, such as an organization or an individual, that acquires electric power. The acquirer in this case is the user D.

### Charging Data Management Table

FIG. 5 is a conceptual diagram illustrating an example charging data management table. The storage unit 3000 stores a charging data management table 3002. As illustrated in FIG. 5, the charging data management table 3002 stores the acquirer identification information (the vehicle number and the battery number) of FIG. 4, and charging data including the charging date and time and the charging power (charging amount), in association with each other. The charging date and time indicates the date and time when electric power is charged for the acquirer. The charging power is an amount of electric power having been charged.

### Functional Configuration of Charging Connector

The communication unit 31, which is implemented by instructions of the CPU 101 with respect to the external device connection I/F 105 or the network I/F 106, accesses the node 9 via the intermediary server 5 to establish communication.

The reception unit 32, which is implemented by instructions of the CPU 101 with respect to the input device 108, receives various selections or inputs from the user D.

The measurement unit 33, which is implemented by instructions of the CPU 101 with respect to the measurement sensor 111, measures a charging power (an example of an amount of an asset being acquired).

The display control unit 34, which is implemented by instructions of the CPU 101 with respect to the display 107, controls the display 107 (as an example of displaying unit) to display various characters or images.

### Functional Configuration of Retailer Terminal

As illustrated in FIG. 3, the retailer terminal 8 includes a communication unit 81, a reception unit 82, a measurement unit 83, and a display control unit 84. These units are functions implemented by or caused to function by operating any of the hardware elements illustrated in FIG. 2 in cooperation with the instructions of the CPU 101 according to the control program expanded from the SSD 104 to the RAM 103.

The retailer terminal 8 further includes a storage unit 8000 implemented by the ROM 102, RAM 103, and SSD 104 illustrated in FIG. 2.

The communication unit 81, the reception unit 82, the measurement unit 83, and the display control unit 84 are the same or substantially similar in function to the communication unit 31, the reception unit 32, the measurement unit 33, and the display control unit 34 of the charging connector 3, respectively, so that description thereof is omitted. The communication unit 81 is able to communicate with the node 9 without intervening the intermediary server 5. The measurement unit 83 measures an amount of electric power supply, which is to be sold by the retailer B to the consumer C.

### Functional Configuration of Node

As illustrated in FIG. 3, the node 9 includes a communication unit 91, a transaction processor 96, and an asset processor 97. These units are functions implemented by or caused to function by operating any of the hardware elements illustrated in FIG. 2 in cooperation with the instructions of the CPU 101 according to the control program expanded from the SSD 104 to the RAM 103.

The node 9 further includes a storage unit 9000 implemented by the ROM 102, RAM 103, and SSD 104 illustrated in FIG. 2. FIG. 3 illustrates a state in which transaction information is connected like a chain. The node 9 further stores asset information generated based on the transaction information. The transaction information and the asset information are stored at each node.

The communication unit 91, which is implemented by instructions of the CPU 101 with respect to the external device connection I/F 105 or the network I/F 106, communicates with the charging connector 3, the retailer terminal 8, or the other node 9 via the intermediary server 5.

The transaction processor 96, which is implemented by instructions of the CPU 101, performs processing such as generating transaction information indicating a transaction causing generation of asset information and storing the transaction information in the storage unit 9000.

The asset processor 97, which is implemented by instructions of the CPU 101, performs processing such as generating asset information according to the transaction information and storing the asset information in the storage unit 9000.

### Processes and Operations

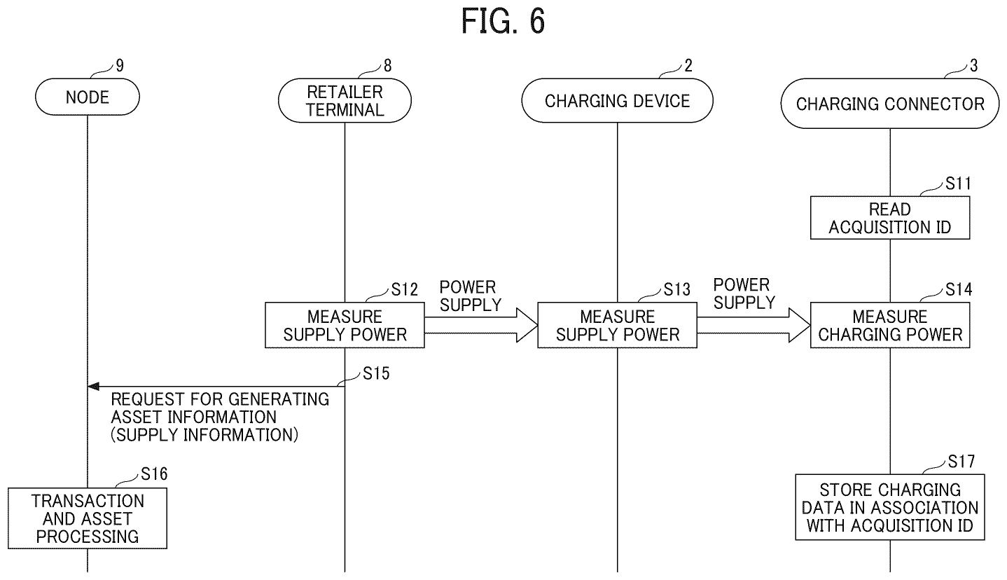

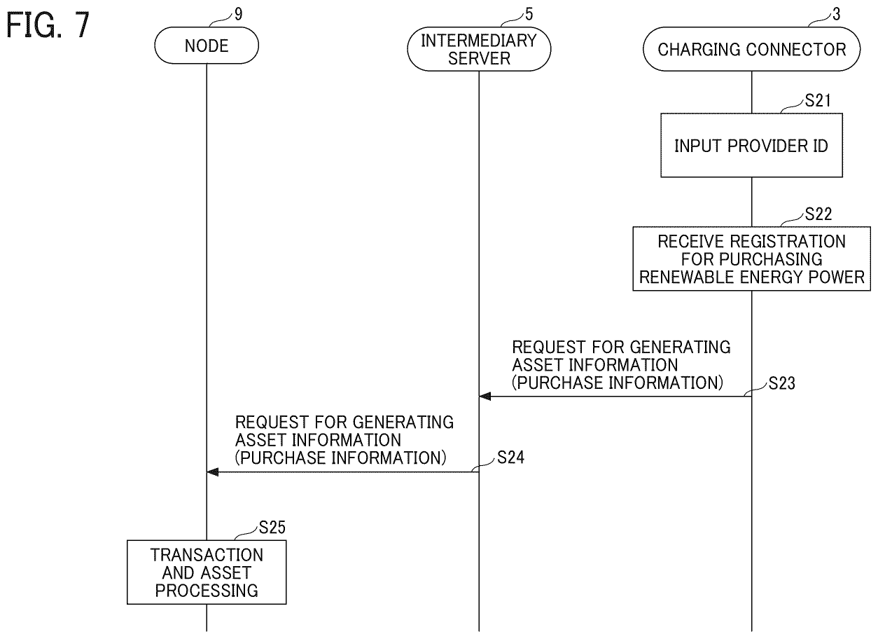

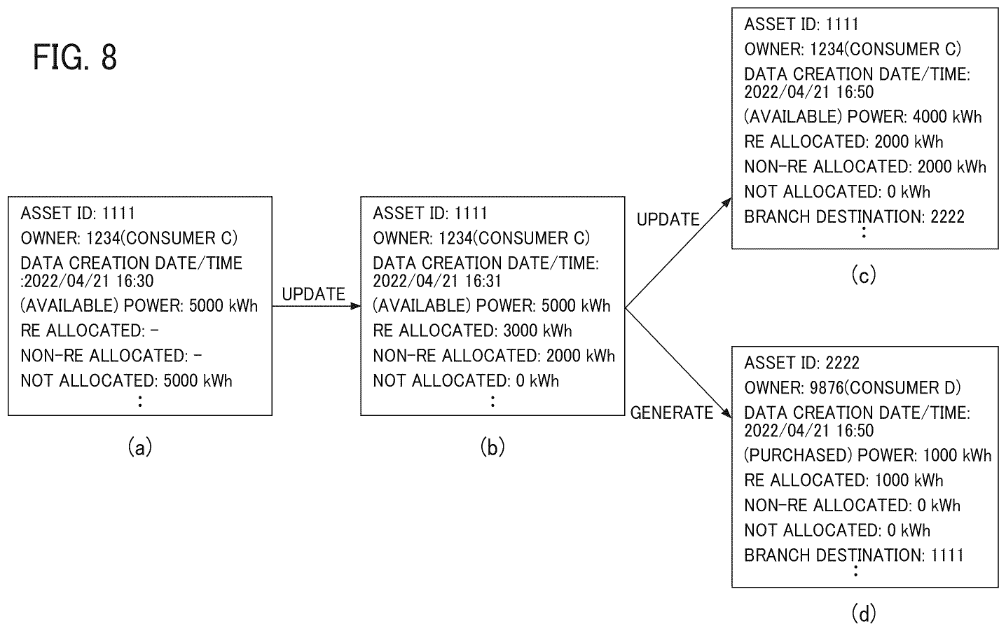

Referring now to FIG. 6 to 8, processing or operation of managing demand and supply of electricity is described according to the embodiment. FIG. 6 is a sequence diagram illustrating processing of charging a battery of an electric vehicle using a charging connector, according to the embodiment. FIG. 7 is a sequence diagram illustrating processing of registering a purchase of electric power produced from renewable energy, according to the embodiment. FIG. 8 is a conceptual diagram illustrating asset information generated based on the processing of FIGS. 6 and 7, according to the embodiment. The processing or operation of FIGS. 6 and 7 is performed when the user D wants to charge a battery of the electric vehicle 7 at the charging station of the consumer C, as illustrated in FIG. 1. Specifically, the user D takes out the dedicated charging connector 3 (with the charging cable 4), which is provided for the electric vehicle 7. The user D then connects the charging cable 4 to the charging device 2, and connects the charging connector 3 to the electric vehicle 7.

### Processing or Operation of Charging

Referring to FIG. 6, at S11, as the user D turns on a power switch of the charging connector 3, the reception unit 32 receives an instruction of turning-on of the switch. The measurement unit 33 reads a set of the vehicle number and the battery production number of the electric vehicle 7 (i.e., the acquirer identification information), from the acquirer identification information management table 3001 of the charging connector 3. The charging connector 3 starts charging the battery of the electric vehicle 7 with electric power supplied at the charging station.

At S12, as electric power is supplied from the retailer B to the consumer C (charging station), the measuring unit 83 of the retailer terminal 8 measures an amount of electric power being supplied from the retailer B to the consumer C.

At S13, as electric power is supplied from the charging device 2 of the consumer C (charging station) to the charging connector 3, the charging device 2 measures an amount of electric power being supplied from the charging device 2 (consumer C) to the charging connector 3 (user D).

At S14, at the charging connector 3, the measurement unit 33 measures an amount of electric charge (an example of an acquired amount) to the battery. S12, S13, and S14 may be performed concurrently.

The communication unit 81 of the retailer terminal 8 transmits a request for generating asset information to the node 9 on the blockchain network 90 every predetermined time (for example, every 30 minutes). The request for generating asset information includes supply information. The supply information includes, for example, information used for generating asset information of FIG. 8(a), such as owner identification information, an amount of power consumption (amount of power supply), etc. The communication unit 91 of the node 9 receives the request for generating asset information. In response to such request, the node 9 generates transaction information including information indicating an instruction to generate asset information and supply information.

In a substantially similar manner, at S15, the communication unit 81 of the retailer terminal 8 transmits a request for generating asset information to the node 9 on the blockchain network 90. The request for generating asset information includes supply information. The supply information, for example, includes information used for generating asset information as illustrated in FIG. 8(a), such as owner identification information, an amount of power consumption (amount of power supply), etc. The supply information further includes a creation date and time when the asset information is generated. The supply information further includes an allocation ratio of electric power produced from renewable energy, and an allocation ratio of electric power not produced from renewable energy. The allocation ratio of electric power produced from renewable energy and the allocation ratio of electric power not produced from renewable energy are preset based on a contract between the retailer B and the consumer C. The communication unit 91 of the node 9 receives the request for generating asset information.

At S16, at the node 9, the transaction processor 96 generates transaction information using the supply information received at S15, and stores the transaction information in the storage unit 9000. The transaction information includes, for example, information indicating an instruction to generate asset information, and the supply information. The asset processor 97 generates the asset information illustrated in FIG. 8(a) based on the transaction information, and stores the generated asset information in the storage unit 9000.

As the transaction information is updated to reflect a transaction in relation to electric power managed with the generated asset information, the asset information is updated. For example, the transaction information may include information indicating an instruction to update the asset information. In such case, the asset processor 97 changes the asset information illustrated in FIG. 8(a) to the asset information illustrated in FIG. 8(b), to reflect the transaction based on the transaction information.

The asset information includes an asset ID for identifying the asset information, owner identification information identifying an owner of electric power, date and time when the asset information is generated, an amount of electric power with its status (for example, available, i.e., tradable, or purchased), an allocated amount of electric power produced from renewable energy (“RE ALLOCATED”), an allocated amount of electric power not produced from renewable energy (“NON-RE ALLOCATED), and an unallocated amount of electric power (“NOT ALLOCATED”).

In this example, as illustrated in FIG. 8(a), the asset information indicating that electric power is supplied to the consumer C, who is an owner of the electric power as a supply destination, in a power amount (supplied power amount) of 5000 kWh. At this point, an allocated amount of electric power produced from renewable energy and an allocated amount of electric power not produced from renewable energy are not determined. As illustrated in FIG. 8(b), the asset information is updated to further indicate the determined allocated amount of electric power produced from renewable energy and the determined allocated amount of electric power not produced from renewable energy, both for the consumer C who is the owner of electric power as the supply destination.

At S17, at the charging connector 3, the measurement unit 33 stores, in the charging data management table 3002, charging data in association with the acquirer identification information read at S11. The charging data indicates an amount of electric charge measured at S14

Registration of a Purchase of Electric Power Produced from Renewable Energy

Referring to FIG. 7, at S21, the user D looks at provider identification information, which may be displayed at the charging station, such as at the charging device 2, and inputs the provider identification information with the input device 108 of the charging connector 3. The reception unit 32 receives the input of the provider identification information. The provider identification information is any information for identifying the charging station or the charging device 2 at the consumer C, or the consumer C. For example, the provider identification information may be an identifier (ID), a name, or a shop name of the customer. With this provider identification information, the electric power purchased by the user D is associated with the consumer C who sells the electric power to the user D.

At S22, the user D operates a screen provided for the charging connector 3 using the input device 108, to register, to the blockchain network 90, information indicating that the electric power currently being charged is produced from renewable energy. The reception unit 32 receives a registration indicating that electric power produced from renewable energy is, or has been, purchased.

At S23, the communication unit 31 transmits a request for generating asset information to the intermediary server 5. The request for generating asset information includes purchase information. In this example, the purchase information includes information used for generating the asset information illustrated in FIGS. 8(c) and 8(d), such as the acquirer identification information (obtained at S11), the provider identification information (obtained at S21), a consumption amount of electric power (an example of acquisition amount), etc. The intermediary server 5 receives the request for generating the asset information. For example, an amount of electric power that is acquired is equal to an amount of electric charge obtained at S14 and stored at S17.

At S24, the intermediary server 5 transfers the request for generating asset information, received from the charging connector 3, to the node 9.

At S25, at the node 9, the transaction processor 96 generates transaction information using the purchase information received at S24, and stores the transaction information in the storage unit 9000. Then, the asset processor 97 generates asset information illustrated in FIGS. 8(c) and 8(d) based on the transaction information, and stores the asset information in the storage unit 9000.

In this example, the asset processor 97 changes (updates) contents, from the asset information illustrated in FIG. 8(b), to the asset information illustrated in FIG. 8(c) indicating a remaining amount of electric power after the allocation, based on the amount of electric power produced from renewable energy to be allocated to the user D. The asset processor 97 further generates new asset information of FIG. 8(d) indicating the amount of electric power produced from renewable energy to be allocated to the user D.

The asset information illustrated in FIG. 8(c) indicates the date and time when the asset information is generated, the remaining available (tradable) electric power amount after allocation (4000 kWh), the allocated amount of electric power produced from renewable energy (2000 kWh), the allocated amount of electric power not produced from renewable energy (2000 kWh), and the unallocated amount of electric power (0 kWh), with the asset ID and the owner remaining unchanged from the asset information of FIG. 8(b). The asset information of FIG. 8(c) further indicates an asset ID (2222) of the asset information, which is a branch destination of the asset information of FIG. 8(b).

The asset information illustrated in FIG. 8(d) indicates the asset ID (2222) of the newly generated asset information, the identification information (9876) of the user D as the owner who purchased electric power, an amount of purchased electric power (1000 kWh), the allocated amount of electric power produced from renewable energy (1000 kWh), the allocated amount of electric power not produced from renewable energy (0 kWh), and the unallocated amount of electric power (0) kWh). The asset information of FIG. 8(d) further indicates an asset ID (1111) of the asset information as a branch source of the asset information of FIG. 8(d).

As described above, the charging connector 3 registers, to the blockchain network 90, data (asset information) indicating that electric power derived from renewable energy has been purchased by a particular user. The individual (or organization such a company) is able to use such data, for example, to enhance public image of the individual or the company (for example, by applying for a production method certificate), or to apply the government for a subsidy based on use of renewable energy using such data or the production method certificate.

According to one or more embodiments described above, even when an unspecified number of users purchases or uses a specific asset, such as electric power produced from renewable energy, such purchase or use of the specific asset can be easily proved.

For example, in the case of asset being electric power, there may be an unspecified number of charging targets, such as electric vehicles, which may be owned by an unspecified number of companies or individuals.

With the above-described system, when data regarding charging of electric power is recorded on the common data infrastructure, such as the blockchain network, a particular electric vehicle can be identified, which has been charged with electric power derived from renewable energy. This allows the user to prove a purchase or use of electric power derived from renewable energy.

In the above-described embodiment, electricity or electric power is used as an example of asset, but the asset is not limited to electricity or electric power, such that examples of the asset may include hydrogen. The charging system 1 is an example of a demand-supply system. When hydrogen is used as asset, the demand-supply system also includes a filling system for filling hydrogen. Further, instead of the electric vehicle 7, a hydrogen vehicle, such as a fuel cell electric vehicle, is used. The charging connector 3 is an example of an acquirer device. In the case of using hydrogen as asset, the acquirer device also includes a hydrogen filling connector for acquiring hydrogen. In the case of using hydrogen as asset, a hydrogen filling connector is used instead of the charging cable 4. In alternative to the charging station having the charging device 2, the hydrogen filling station having a filling device is provided.

In the above-described embodiment, the charging connector 3 acquires the provider identification information, which has been input by the user D (processing of S21), but the provider identification information may be acquired in various other ways. For example, the charging connector 3 may be provided with a camera. The reception unit 32 may obtain the provider identification information by capturing the provider identification information on the charging device 2 with the camera. In another example, the reception unit 32 may obtain the provider identification information by capturing code information such as a two-dimensional code or a barcode on the charging device 2 with the camera, and reading the provider identification information embedded in the code information using, for example, a code reader.

In this disclosure, the CPU 101 may be a single device or a plurality of devices.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), System on Chip (SOC), and graphical processing unit (GPU), and conventional circuit components arranged to perform the recited functions.

Further, any one of the above-described control programs may be recorded in a file in a format installable or executable on a computer-readable recording medium for distribution. Examples of the recording medium include a compact disc recordable (CD-R), a digital versatile disk (DVD), a Blu-ray Disc, an SD card, and a USB memory. Further, any of the above-described programs may be stored in a recording medium either temporarily or non-temporarily. In addition, such recording medium may be provided in the form of a program product to users within a certain country or outside that country.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A device for acquiring an asset, comprising:
a memory that stores acquirer identification information for identifying an acquirer of the asset; and
circuitry configured to
receive provider identification information for identifying a provider of the asset,
measure an amount of the asset acquired, and
transmit the acquirer identification information stored in the memory, the provider identification information that is received, and the amount of the asset acquired, each to be received at a blockchain network.

2. The device of claim 1, wherein the circuitry receives the provider identification information through image capturing.

3. The device of claim 1, wherein the device is a charging connector for an electric vehicle and the asset is electric power.

4. The device of claim 1, wherein the device is a hydrogen filling connector for a hydrogen vehicle and the asset is hydrogen.

5. A system comprising:
a device for acquiring an asset, including:
a memory that stores acquirer identification information for identifying an acquirer of the asset; and
circuitry configured to receive provider identification information for identifying a provider of the asset, measure an amount of the asset acquired, and transmit the acquirer identification information stored in the memory, the provider identification information that is received, and the amount of the asset acquired, to be received at a blockchain network; and
a device for providing the asset.

6. A method of acquiring an asset, comprising:
storing, in a memory, acquirer identification information for identifying an acquirer of the asset;
receiving provider identification information for identifying a provider of the asset;
measuring an amount of the asset acquired; and
transmitting the acquirer identification information stored in the memory, the provider identification information that is received, and the amount of the asset acquired, each to be received at a blockchain network.

7. A non-transitory recording medium storing a plurality of instructions which, when executed by one or more processors, causes the one or more processors to perform a method of acquiring an asset, comprising:
storing, in a memory, acquirer identification information for identifying an acquirer of the asset;
receiving provider identification information for identifying a provider of the asset;
measuring an amount of the asset acquired; and
transmitting the acquirer identification information stored in the memory, the provider identification information that is received, and the amount of the asset acquired, each to be received at a blockchain network.
